(19) United States
(12) Patent Application Publication
(10) Pub. No.: US 2009/0214855 A1
(43) Pub. Date: Aug. 27, 2009

(54) FLOOR WITH A CHAFE RESISTANT OVERLAY PAPER

(75) Inventors: Reinhard Kreuder, Bad Berleburg (DE); Klaus Fischer, Bad Berleburg/Berghausen (DE)

Correspondence Address: MCCORMICK, PAULDING & HUBER LLP, CITY PLACE II, 185 ASYLUM STREET, HARTFORD, CT, 06103, US

(73) Assignee: Dekor-Kunststoffe GmbH, Erndtebrueck (DE)

(21) Appl. No.: 12/369,082

(22) Filed: Feb. 11, 2009

(30) Foreign Application Priority Data
Feb. 12, 2008 (DE) 20 2008 001 938.9

(51) Int. Cl. B32B 5/16; B32B 23/00

(52) U.S. Cl. 428/323; 428/532; 428/342

(57) ABSTRACT

The invention relates to a floor panel (100), in particular for a laminates floor with a decorative layer and with an overlay paper which has a cellulose layer (10). In order to provide a floor panel (100), which better satisfies the requirements for the overlay film for abrasion resistance and pressing plate protection on the one hand and microscratch—or chafe resistance on the other hand the invention proposes that coarse corundum particles (15) lie on the underside of the cellulose layer (10), i.e. on the side of the cellulose layer (10) facing the decorative layer, and fine corundum particles (13) lie on the upper side of the cellulose layer (10), i.e. on the side of the cellulose layer (10) facing away from the decorative layer.

### CROSS REFERENCE TO RELATED APPLICATION

This application claims the benefit of German Application No. 202008001938.9, filed Feb. 12, 2008, the disclosure of which is herein incorporated by reference in its entirety.

### FIELD OF THE INVENTION

The invention relates to a floor panel, in particular for a laminate floor, with a decorative layer and an overlay paper which has a cellulose layer.

### BACKGROUND OF THE INVENTION

Floor panels of the type mentioned in the introduction are, in particular, components of decor laminates. Characteristics such as abrasion resistance and wear resistance are of not insignificant relevance for the quality of such decor laminates. An optimal representation of the decoration is then only obtained when the overlay films which are used for production ensure a high degree of transparency.

A structure of a floor panel known from the prior art is formed such that a so-called overlay paper, impregnated with melamine resins, serves as the uppermost layer. Beneath this uppermost layer there is situated an impregnated printed paper which forms the decorative layer of the finished floor panel and sits on the sheet of wood material serving as a support. The floor panel ends with a backing paper, impregnated with melamine—and/or hard material resins, which is pressed onto the rear side of the wood material sheet and the function of which is to prevent, through a symmetrical structure of the floor, a warping and dishing of the finished floor panels.

In order to improve the required abrasion resistance of such laminates, one has switched over to introducing corundum particles into the overlay paper. According to the liquid overlay method, which today constitutes the main manufacturing method for such overlays, the corundum particles, which are responsible for the high abrasion resistance, are placed beneath the cellulose layer of the overlay base paper. Through this, the advantage results that the pressing plates which are used for pressing the individual layers of the laminate floor can not be damaged by the corundum particles in the overlay film, because there is a protective layer of cellulose between the pressing plate and the corundum.

The position of the corundum particles in the overlay is therefore determined in that they must on the one hand protect the decorative printed layer from wearing through, but on the other hand are also to have as great a distance as possible from the actual surface of the finished laminate floor, to protect the sensitive pressing plates.

In recent years, the requirements for the design of laminate floors have increased considerably. This relates not only to the actual decorative print, but also to the characteristics of the laminate surface given by means of the pressing process and hence by means of the pressing plate. In addition to a wood pore structure synchronized with the print image and more intensively relief-like surfaces (so-called handscraped designs), the degree of sheen of the surface is also to be mentioned here, which can vary from mat to intensively glossy.

In particular with regard to the degree of sheen, the requirement from the laminate floor manufacturers exists that the laminate floor surface is to have a chafe—or microscratch resistance. Hereby, fine scratches on the surface are avoided, which can already occur during the manufacture and transportation to the end customer and which are intrusively noticeable in particular on dark decors. In addition, such products have the advantage that they also change less intensively in the degree of sheen during use. Typical traces of use and changes in degree of sheen on floor areas which are frequently walked over are hereby avoided. Glossy surfaces are made mat much less through microscratches, mat surfaces are polished up much less by use.

Similar requirements for a better microscratch—or chafe resistance are also made with regard to furniture surfaces. Although here a different structure of the surface is present and normally no overlays are used to protect the decorative film, the principle used by us to increase the chafe resistance can also be used very well here.

It is therefore an object of the invention to provide a floor panel of the type mentioned in the introduction, which better satisfies the requirements for the overlay film for abrasion resistance and pressing plate protection on the one hand and microscratch—or chafe resistance on the other hand.

With regard to the production of a chafe resistant furniture surface, it is an object of the invention to provide a resin-impregnated decorative paper which has a good chafe—and microscratch resistance, without affecting the pressing plates.

This problem is solved by the present invention.

Advantageous developments of the invention are also described.

### SUMMARY OF THE INVENTION

The requirements with regard to the overlay film for abrasion resistance and protection of the pressing plates on the one hand, and microscratch—or chafe resistance on the other hand are therefore solved in accordance with the invention in that

the relatively coarse corundum particles necessary for the abrasion resistance lie on the side facing the decoration and

the fine corundum particles necessary to achieving the chafe resistance lie on the upper side of the cellulose layer.

The necessary protection of the pressing plates is ensured by means of the grain size and the grain form of the fine corundum which is used. The smaller the grain, the less will be its abrasion or damage to the pressing plate in the case of contact therewith. Through the use of a platelet-shaped corundum, which through the application method and the pressing is preferably aligned parallel to the surface, likewise the risk of damage to the pressing plates is reduced, because the sharper edged narrow sides of the corundum platelets are not oriented to the plate.

Through the choice of the grain size and of the grain form, and the systematic placing of these corundum types in the product—or overlay structure, the requirement for chafe resistance of the uppermost laminate layer on the one hand, and for protecting of the pressing plates on the other hand, is therefore fulfilled.

In the case of chafe resistance furniture surfaces, only fine corundums are used in the layer close to the surface, because here, in contrast to the floor, much less stress exists and coarse corundums do not have to be used.

Preferably, the cellulose layer of the overlay paper is provided with a covering coat of resin which contains the fine corundum particles.

The relatively coarse corundum particles responsible for the abrasion resistance, which are applied on the side of the overlay film facing the decoration, have grain sizes of 30 μm to 125 μm in accordance with the prior art.

The fine corundum particles responsible for the chafe resistance, which are situated on the upper side in a layer close to the surface, have a grain size of 0.5-50 μm, particularly preferably between 2 μm and 30 μm.

The best chafe resistances are produced when the fine corundum particles, introduced in the form of a covering coat, are used with a mass proportion of 0.5%-50% in the covering coat resin; a proportion of 3-30% has proved to be particularly advantageous (proportions in relation to dry resin).

A practicable variant of the invention therefore makes provision that the application weight of the covering coat is between 1 g/m² and 50 g/m². In order to limit the costs of the additional covering coat resin, the application weight of the covering coat resin can also be between 5 g/m² and 30 g/m².

### BRIEF DESCRIPTION OF THE DRAWINGS

The invention is explained in further detail below with the aid of the FIGURE.

There is shown in diagrammatic representation:

FIG. 1 a sectional view of a floor panel according to the invention.

### DESCRIPTION OF THE PREFERRED EMBODIMENTS

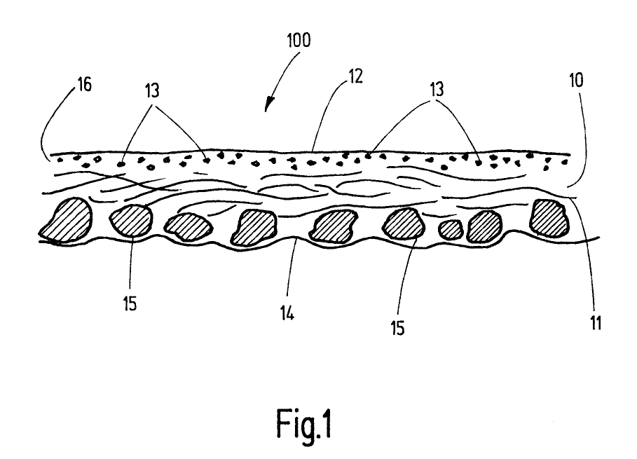

The floor panel illustrated in FIG. 1, which is present in the form of a laminate floor panel, is given reference number 100.

A structure of a floor panel known from the prior art is formed such that a so-called overlay paper, impregnated with melamine resins, serves as the uppermost layer. Beneath this uppermost layer there is situated an impregnated printed paper which forms the decorative layer of the finished floor panel and sits on the wood material sheet serving as a support. The floor panel ends with a backing paper, impregnated with melamine—and/or hard material resins, which is pressed onto the rear side of the wood material sheet and the function of which is to prevent, through a symmetrical structure of the floor, a warping and dishing of the finished floor panels.

This structure of a floor panel, known per se, is extended in the embodiment illustrated in FIG. 1 by a covering coat 12 of resin, which is situated on the cellulose layer 10 of an overlay paper. The cellulose layer 10 is composed of cellulose fibres 11 and is impregnated with the resin in the form of a special melamine resin or a mixture of melamine resin and another resin. In the covering coat 12, fine corundum particles 13 are present, distributed uniformly; the average grain size of these finely distributed particles 13 lies in the range of 2 μm and 30 μm. The mass proportion of the fine-particulate fine corundum particles 13 in the covering coat 12, in relation to a dry covering coat, is between 3% and 30 33%. The application weight of the covering coat 12 amounts to 5 g/m² to 30 g/m².

In addition, the underside of the cellulose layer 10 is provided with a further resin coat 14. This coating of the cellulose layer 10, present in the form of a resin layer, lying on the side facing a decorative layer, additionally contains coarse corundum particles 15, so that the resin layer 14 can function as a further abrasive layer.

The present invention is not limited in its embodiment to the preferred example embodiment indicated above. Rather, a number of variants are conceivable which make use of the illustrated solution also in basically differently developed embodiments. The covering coat can therefore consist of different resins. Also, depending on the desired abrasion resistance and transparency, different fine corundum particles and grain sizes can be used. In addition, various methods can be taken into consideration for the application of the covering coat resin 12 and of the resin coat 14 within the framework of the invention.

### LIST OF REFERENCE NUMBERS

| | |
|---|---|
| 100 | floor panel |
| 10 | cellulose layer |
| 11 | cellulose fibres |
| 12 | covering coat |
| 13 | fine corundum particles |
| 14 | resin layer |
| 15 | corundum particles |
| 16 | dispersion |

1. Floor panel (100), in particular for a laminate floor with a decorative layer and with an overlay paper which has a cellulose layer (10), characterized in that coarse corundum particles (15) lie on the underside of the cellulose layer (10), i.e. on the side of the cellulose layer (10) facing the decorative layer, and fine corundum particles (13) lie on the upper side of the cellulose layer (10), i.e. on the side of the cellulose layer (10) facing away from the decorative layer.

2. Floor panel according to claim 1, characterized in that the cellulose layer (10) of the overlay paper is provided with a covering coat (12) of resin, which contains the fine corundum particles (13).

3. Floor panel according to claim 1, characterized in that the grain sizes of the fine corundum particles (13) are between 0.5 μm and 50 μm.

4. Floor panel according to claim 3, characterized in that the grain sizes of the fine corundum particles (13) are between 2 μm and 30 μm.

5. Floor panel according to claim 1, characterized in that the mass proportion of the fine corundum particles (13) in the covering coat (12) is between 0.5% and 50%.

6. Floor panel according to claim 5, characterized in that the mass proportion of the fine corundum particles (13) in the covering layer (12) is between 3% and 30%.

7. Floor panel according to claim 1, characterized in that the fine corundum particles (13) are present finely distributed in the covering coat (12).

8. Floor panel according to claim 1, characterized in that the application weight of the covering coat (12) is between 1 g/m² and 50 g/m².

9. Floor panel according to claim 8, characterized in that the application weight of the covering coat (12) is between 5 g/m² and 30 g/m².

10. Floor panel according to claim 1, characterized in that a resin coat (14) provided with the corundum particles (15) is placed on the underside of the cellulose layer (10).

11. Floor panel according to claim 10, characterized in that the grain size of the corundum particles (15) is between 10 μm and 200 μm.

12. Floor panel according to claim 11, characterized in that the grain size of the corundum particles (15) is between 30 μm and 150 μm.
